(19) United States
(12) Patent Application Publication
(10) Pub. No.: US 2018/0067474 A1
(43) Pub. Date: Mar. 8, 2018

(54) CONTROL DEVICE FOR A MACHINE

(71) Applicant: MAHA MASCHINENBAU HALDENWANG GMBH & CO. KG, Haldenwang (DE)

(72) Inventor: Markus Andreas STULLE, München (DE)

(73) Assignee: MAHA MASCHINENBAU HALDENWANG GMBH & CO. KG, Haldenwang (DE)

(21) Appl. No.: 15/699,739

(22) Filed: Sep. 8, 2017

(30) Foreign Application Priority Data
Sep. 7, 2016 (DE) 10 2016 217 030.9

(51) Int. Cl. G05B 19/4063; G05B 19/4093; H04L 29/08; G01M 17/007; H04L 12/24

(52) U.S. Cl. CPC G05B 19/4063; G05B 19/4093; H04L 67/2804; H04L 41/0803; H04L 67/34; H04L 67/141; G01M 17/007

(57) ABSTRACT

A control device for controlling a machine that may be configured for exchanging data with one or more actuators of the machine and/or for exchanging data with one or more sensors of the machine.

The present invention relates to a control device of a machine that can communicate wirelessly, directly, and in real time with a background management system (a server farm, a cloud service system, a computing center, a network server, for example) situated remotely from the machine. The machine is preferably a vehicle testing device or lifting device.

Machines having a control device are known in the prior art, but these machines or control devices cannot exchange data directly, wirelessly, and in real time with a server farm. Instead, known machines are connected via a cable connection to a local personal computer (PC), which may then be connected to a network.

Thus, machines known heretofore are not able to communicate with a network wirelessly and directly, i.e., without going through the connected PC, and therefore are also not able to independently send data to a network. The hardware architecture, which requires a number of buffering steps and relaying of data via the PC, also does not allow transfer of data in real time; i.e., the data transfer, in terms of time, cannot keep up with the generation of data from the sensors and the actuators of the machine. The processing and use of real time data are thus hampered, which is a barrier to improving the reliability, production availability, cost efficiency, and/or efficient implementation and planning of maintenance and repair activities.

It is an object of the present invention to provide a control device of a machine that is able to exchange data with a network directly, wirelessly, and with real-time capability. A further aim is to provide a background management system that processes and evaluates data, sent from the control device of the machine, to be able to provide a user with information concerning the status and other properties and functions of the machine. A further aim is to provide associated repair and maintenance methods as well as a start-up method for the machine, which ensure greater cost efficiency in addition to more efficient work operations, for example during repair or maintenance, and provide improved security to the user. In summary, the aim is to provide a machine that is improved in terms of reliability, production availability, cost efficiency, and/or implementation and planning capability of maintenance and repair activities.

The object is achieved by the invention according to the independent patent claims. Further preferred refinements of the invention are described in the dependent patent claims.

The control device according to the invention for controlling a machine may be configured for exchanging data with one or more actuators of the machine. The data may contain, among other things, control signals as well as measured values and status information concerning the actuator. In addition, the control device may be configured for exchanging data with one or more sensors of the machine. The data exchange between the control device and the actuators/sensors may have a unidirectional or bidirectional design.

The machine may in particular comprise vehicle lifting devices, vehicle brake test stands, vehicle test lanes, vehicle dynamometers, exhaust gas measuring devices, and/or other test devices for motor vehicles.

The data exchange between the control device and the actuators/sensors is preferably carried out in a wired manner. When the actuators/sensors have wireless transmission modules, the data exchange between the control device and the actuators/sensors may particularly preferably take place cordlessly in view of the better maintainability, accessibility, operational flexibility, and weight savings, for example via a radio link between the control device and an actuator or sensor.

Furthermore, the control device may contain a processing unit. The processing unit may be a microcontroller, an ASIC, or a microprocessor, for example. The processing unit may in particular be configured for controlling the actuators of the machine and/or retrieving data from the sensors.

Moreover, the control device may contain a wireless transmit/receive unit that may in particular be configured for wirelessly transmitting data from the actuators and/or sensors, preferably upon command by the processing unit, to one or more networks, which are local or preferably global, and/or for receiving data from the network. The network may be a local or a global network. The network is particularly preferably the Internet.

The control device may preferably be fixedly connected to the machine. The control device's own wireless transmit/receive unit may be a radio chip, which particularly preferably is a microelectronic wireless local area network (WLAN) module. However, the wireless transmit/receive unit may also be a microelectronic module that controls one or more other wireless transmission paths, for example standardized methods such as Bluetooth, GSM, UMTS, LTE, etc., or also proprietary methods. The control device thus allows the machine to send data, such as telemetry data of the actuators and/or sensors, to a network which particularly preferably is the Internet, or to a network/Internet-connected router or the like, directly, i.e., without going through a connected PC or the like. In addition, the wireless transmit/receive unit makes it possible to transmit data to and from the vehicle testing device in a cordless manner, i.e., wirelessly.

In addition, the complexity of the hardware architecture of the control device is reduced in such a way that data may be processed very quickly, so that this processing is real-time capable. In the present context, “real-time capable” is intended in particular to mean that the control device is able to keep up with the events of the control path. In other words, this may mean, for example, that the control device is able to initiate an emergency stop of a vehicle lifting platform quickly enough, for example in a few milliseconds, when the lifting platform encounters an obstacle when moving up or down. This may also mean that the measured value data generated by sensors, which may be generated by the sensor every 10, 20, 30, or 50 milliseconds, for example (or at larger or smaller time intervals), may be received from the control device at the same or a similar frequency and relayed/transmitted to the network. This real-time capability may be achieved, for example, in that a particularly preferred control device according to the invention has as main components essentially only the wireless transmit/receive unit, the processing unit (particularly preferably both combined into a single microelectronic module), and electrical connecting lines and input/output lines. These may be combined into a core module. The complexity of the circuitry and the required number of necessary microelectronic modules of this core module are reduced in such a way that the control device may provide very rapid data processing; in particular, the real-time capability is further assisted when the processing unit is a powerful, modern microcontroller, ASIC, or microprocessor having a high operating speed. A high operating speed may be achieved, for example, by a high clock frequency of several MHz up to several GHz, and/or by multiple processor cores and a fast cache. Of course, the core module may contain additional microelectronic components, although this may be at the expense of the data processing speed in the control device.

The direct, real-time capable, wireless communication of the control device or the machine with the network, preferably the Internet, allows a number of application advantages, which may be summarized in particular under the keywords reliability, machine availability, cost efficiency, and/or improved planning capability for maintenance and repair activities. Thus, the reliability may be increased, for example, by immediately recognizing minor work variances of the machine, such as a deviation from the target values which is not yet visible, but identifiable in the measuring data of the jack screw of a lifting device, based on the telemetry data transmitted in real time, and appropriately adapting possible maintenance cycles in order to prevent major repairs or defects. This in turn increases the machine availability and thus also the cost efficiency, since defects may possibly be avoided altogether. Maintenance and/or repair activities may also be preplanned and/or predicted. The data may also assist with identifying replacement parts that may possibly be needed. Furthermore, for bidirectional data links, updates to the device control firmware may be installed in a timely manner and with little effort. The cordless connection to a network also allows maximum flexibility in setting up and positioning the machine.

In addition, the control device or the machine may be connected via the network to a background management system, to which the data of the control device may be transmitted and/or from which data may be transmitted to the control device.

The connection to a background management system, which is preferably a server farm, a computing center, or the like, and which may be connected to the control device or to the machine via the Internet, allows, for example, the provision of a data memory storing fairly large quantities of data to be dispensed with. A fairly small data memory that is small enough to buffer data that are to be sent to the network in the near term or to be received from the network is sufficient. The actual data storage then takes place in the background management system, which may be situated remotely from the machine. The background management system particularly preferably maintains an electronic device file, containing information specific to the device, for each control device or machine. For example, individual configurations of a machine may also be stored here, which for a lifting platform, for example, establish the cutoff level or the anti-crush protection stop on a user-specific basis. Externalizing the data storage and computation-intensive software functions from the machine or the control device to a background management system thus allows the operating speed of the control unit, which assists with the real-time capability of the data processing, to be further speeded up.

Furthermore, the control device may have an electronic module on which the processing unit and the wireless transmit/receive unit or the core module may be situated, and these may be electrically connected to one another by means of strip conductors of the circuit board. The circuit board may also have inputs and outputs for lines to and from the actuators and/or sensors, and a power supply connection. A cable connection for data links, for example a USB connection, and/or jumpers may also optionally be provided. The reduced number of components on the circuit board of the control device allows a compact design.

Moreover, the processing unit and/or the control device may have a memory for the firmware of the control device, and optionally a preferably volatile memory for buffering incoming and outgoing data. The size of the memory modules is preferably dimensioned to be small enough that the control device has a preferably compact design, and to be large enough that the firmware and at least the volume of data from the sensors/actuators as well as their control commands can be buffered for a specified period of time, for example from a few seconds to several hours.

In addition, the memory of the control device may be delivered without firmware prior to start-up. The control device may then be configured for obtaining or receiving via transmission the firmware from the background management system by means of a data link via the network and storing same. Furthermore, the control device may be configured for obtaining firmware updates in the same manner. Centralizing the management of the firmware and updates allows mechanical and electronic components in manufacture and delivery to be identical or very similar, and an individual, user-specific configuration may be made afterwards, for example at start-up. This configuration may then also be securely stored in the centrally managed device file of the machine. This is easier for the user even with a new purchase, since he/she may have the configuration of a previous version of a test device transferred to a new one with little effort. In addition, the device firmware cannot be damaged or altered on site, which even further increases the operational reliability.

Moreover, the connection to a background management system may also be advantageous for the user due to the fact that the background management system may provide Internet access software or the like, so that an authorized user may obtain or display data/information concerning the machine in real time, at any time and from any remote point with an Internet connection, or may even carry this out by remote control. Remote control is basically disabled under the machine guidelines, but can be activated or set up. The display of the machine and its measured values may be provided to the user by means of a graphical human-machine interface.

Furthermore, the data link to the background management system may be at least one wired data link path between the control device and a network- or Internet-capable device. This data link may preferably be set up during start-up of the machine, preferably temporarily. This data link may also be used during operation for transmitting data or for installing firmware updates. It is basically advantageous that with this data link/this communication path, another approach is made possible for complete access to the control device and the background management system. The network- or Internet-capable device may be, for example, a PC or some other electronic Internet-capable device such as a smart phone. In addition, at least one cordless or corded data link path may be provided between the network- or Internet-capable device and the background management system.

Furthermore, the wireless transmit/receive unit may have a cryptography module which may be configured for encrypting or decrypting data that are sent or received by the wireless transmit/receive unit, or for providing the data with a digital signature. This ensures the confidentiality and integrity of the transmitted data, and exclusive access to the data for authenticated users.

The control device may also be configured for sending data to the network at predetermined time intervals, which may be regular or irregular, in order to transmit the data to the background management system via the network. The data may in particular contain measured values and status information of the actuators and sensors of the machine. The transmission preferably takes place in the “push method.” For example, the processing unit instructs the sensors to take measurements, record the values, and transmit same as measuring data to the control device. Immediately after input of the measuring data or the like, the processing unit may then order the transmission of these data to the network and the background management system. The transmission takes place via the wireless data connection between the wireless transmit/receive unit and the network or a network gateway, such as a router. The background management system may then receive the data via the network to which it is connected. A user may also obtain access to the data, for example by logging into the appropriate device file on the background management system, using a web app or some other interface, and retrieving prestored information items and/or real time data that have been sent from the control device to the background management system (“pull method”). The user may thus obtain a comprehensive “live” overview of the operability, the general status, etc., of the machine. For bidirectional data links, the user may also relay instructions and control commands to the control device remotely, for example for remotely controlling the machine.

The transmitted data are preferably measuring data of the sensor or sensors of the machine, and/or measuring data or status data of the actuator or actuators of the machine.

The Message Queue Telemetry Transport (MQTT) protocol may preferably be used for the transmission between the control device and the network. The volume of data transmitted may thus be reduced, thereby further improving the real-time capability. Within the meaning of the invention, proprietary protocols that incorporate these properties are also usable.

A background management system according to the invention may be configured for obtaining data via transmission from a control device according to the invention, or transmitting or receiving and sending data to the control device. Furthermore, the background management system may be connected to one or more networks and have a plurality of computers that may be configured in particular for receiving, storing, and processing data and/or transmitting data to the control device or to a user terminal connected to the network. The background management system is preferably a server farm, a computing center, or the like. The background management system may be configured for outputting, upon a request that is entered by a user/user terminal via the network, requested data via the Hypertext Markup Language (HTML) protocol, and updating the display thereof at predetermined time intervals.

In addition, the background management system may be configured for storing for each control device or machine a digital device file that contains information concerning the machine, in particular the service actions, error memory entries (diagnostic trouble codes (DTC)), transmitted raw data of the sensors and actuators, evaluation data of the raw data, or one or more configurations of the machine and/or the firmware, implemented on the machine, it being possible to store the data of the device file in encrypted form.

Moreover, the background management system may be configured for evaluating raw data of the sensors and actuators of the machine transmitted from the control device, and generating evaluation data that may contain information concerning the status of the machine, its use, its use times, or the like.

Furthermore, the background management system may be configured for automatically transmitting the evaluation data to a user/a user terminal when a predefined event has been identified during the evaluation. The event may be, for example, the occurrence of a predetermined state, of a predefined use, etc. For example, the evaluation data may contain information concerning the need for repairs to the machine, and the predefined event may be that a defect in the machine has been detected. In the event of a defect, one or more predetermined users are then immediately notified by sending a message, containing information concerning the defect, to one or more user terminals. A service technician may thus obtain all information concerning the defect, the possible repair, and the required replacement parts and tools in advance, i.e., before arriving at the defective machine, and thus carry out the repair in a time-effective and targeted manner. The same applies for other service tasks such as maintenance. In addition, a corresponding method may be provided according to the invention.

The evaluation data may be raw data, processed according to predetermined patterns, of the sensors and actuators of the machine. For example, in the background management system, raw data of a temperature sensor which is mounted on the machine and which measures the actuator temperature, for example the motor of a jack screw, may be time-averaged and compared to a maximum average value that is predefined in the system. If the average temperature were to exceed the maximum average value, an overload of the actuator or a defect could be concluded, and an automatic message would be sent to a predetermined user. The message may contain, for example, all temperature data in a graphical representation, as well as an automatically generated error diagnosis that may be regarded as plausible based on the observed temperature profile. The user, for example a service technician, may then optimally plan the repair that may be required, and carry out the repair on site with a minimum time expenditure; for example, an on-site error diagnosis is no longer necessary, or requires less time.

Further possible scenarios may be that the evaluation data contain information concerning whether the machine is possibly in need of maintenance or is defective. For example, only slightly abnormal behavior of a jack screw of a vehicle lifting platform may indicate that, although a defect is not present at that moment, early maintenance may prevent a defect, so that extended production down times due to a defect may be prevented. In addition, it may be ensured that the machine is used properly and correctly. For example, the background management system may output a warning to a service technician or some other user when, for example, a strain gauge in a lifting arm of a lifting platform too frequently detects strain that is outside the device specifications, for example because the vehicles are not positioned relative to the lifting columns according to design, and are placed on the recording points. In addition, inoperative machines may be detected, for example when they have not been switched on for an extended period of time, and therefore an actuator has no longer been acted on with current/voltage. In other words, in the absence of current/voltage values, it may be assumed that the machine has been taken out of operation. In this case, the user may be contacted, for example to provide the user with a machine that is better suited for his/her operations.

Processing the raw data of the actuator values, such as voltage, current, etc., and of sensors, such as temperature, strain, path, pressure, orientation, etc., may thus provide the user with considerable added value. In particular, maintenance and repair activities may be projected in advance (“predicted maintenance”). In an optimal manner, the machine no longer fails due to defects.

According to the invention, a system that includes at least the background management system and the control device may also be provided. In addition, the control device of the system may be configured so that, after receiving a predetermined command sequence that has been entered, for example, via a keyboard at the machine, the control device transmits an emergency signal to the background management system. The background management system of the system may deliver a call or a message to a predetermined contact point, which notifies a user at the predetermined contact point of an emergency request and at the same time displays the data of the machine. This allows direct, immediate reporting to predetermined service centers.

Furthermore, the control device of the system may be configured so that, prior to sending a control command to an actuator of the machine, the control device transmits a request to the background management system, and does not send the control command when the background management system does not enable sending of the control command. This makes it possible for use of the machine to be centrally authorized, i.e., enabled or blocked.

A method according to the invention for starting up a control device may have the step of connecting a PC or some other Internet-capable electrical device to the control device via a cable connection. In addition, the PC may be connected to a network to which the background management system is connected, and firmware may be downloaded from a memory location (in the device file of the specific machine) in the background management system that is predetermined for the machine, and may be stored in the control device. This allows, for example, the delivery of machines which have identical or similar hardware, and which may be set up on site in a user-specific manner only by the user according to his/her wishes, by means of software. Moreover, the method does not have to be used just for start-up. Further examples of use would be to [provide] firmware updates and the data transmission between the background management system and the control device in particular when, for example, a cordless connection has failed or cannot be set up. The latter-mentioned case is preferably employed for temporary use, for example in the event that the cordless data link fails.

In summary, the invention thus allows the provision of a machine or a control device for a machine that exchanges data with a network, preferably the Internet, in a direct, real-time capable, and cordless manner. It is thus possible for telemetry data of the machine to be displayed on a remote computer, smart phone, or the like in real time or with only slight delay times, for a background management system to create diagnostic and evaluation data from the received data, which make maintenance and repair activities, for example, predictable and/or plannable, for firmware updates to be installed on the machine by the background management system without the on-site presence of a service technician, for the machine to be remotely controlled, for leasing models indicating the costs per use of the machine to be prepared, for machine-specific data and configurations to be centrally, securely stored, and so forth. In addition, a background management system and corresponding maintenance and start-up methods are provided. In conclusion, the reliability, production availability, cost efficiency, and/or the planning capability and predictability of maintenance and repair activities of the machine are thus improved.

The invention is described below by way of example, with reference to the appended schematic drawings, which show the following:

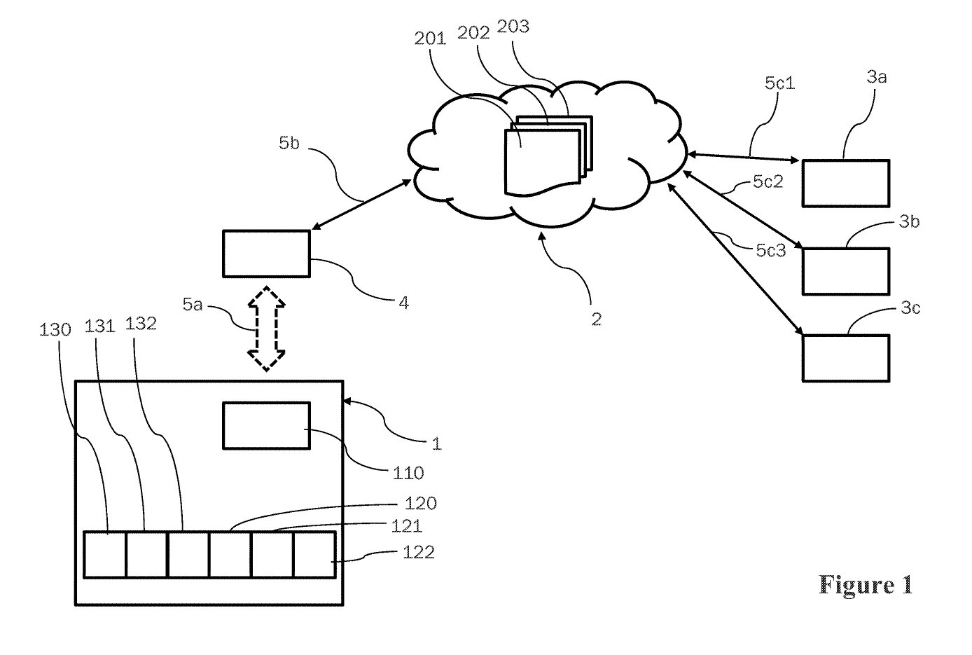

FIG. 1 shows a machine with a control device according to the invention, which is connected to a background management system according to the invention,

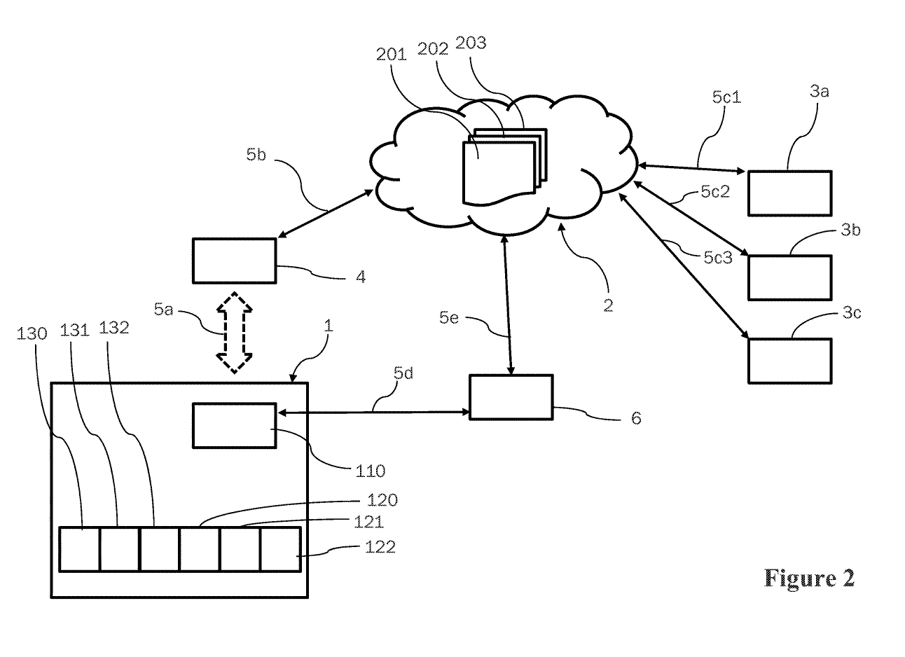

FIG. 2 shows a machine with a control device according to the invention during start-up, and

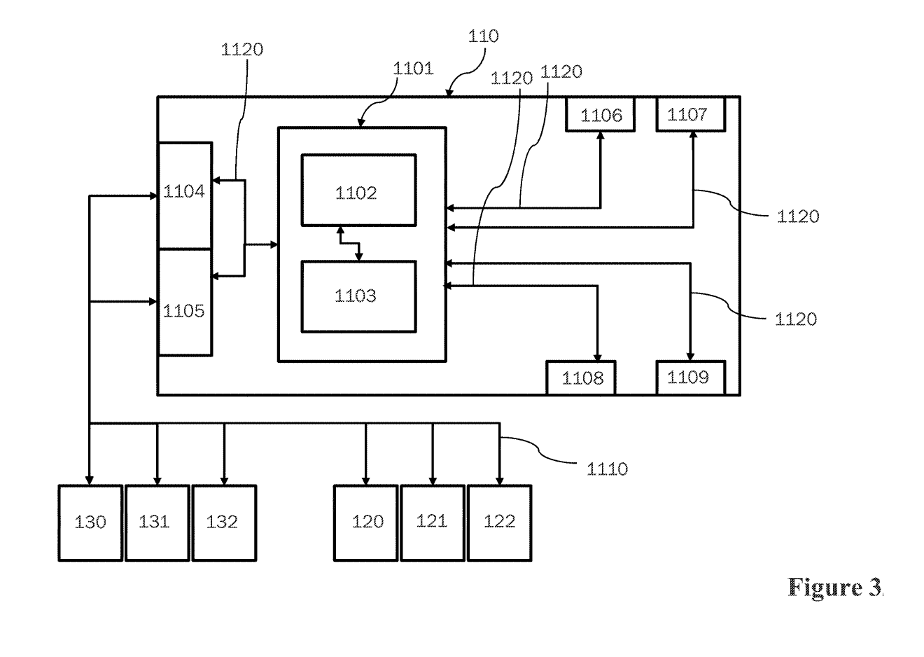

FIG. 3 shows a control device according to the invention.

Various examples of the present invention are described in detail below with reference to the figures. Identical or similar elements are denoted by the same reference numerals in the figures. However, the present invention is not limited to the described embodiment features, but, rather, also includes modifications of features of the described examples and the combination of features of various examples within the protective scope of the independent claims.

FIG. 1 shows a machine 1 which in particular has a control device 110, sensors 120-122 (more than three and fewer than three sensors are possible), and actuators 130-132 (more than three and fewer than three actuators are possible). The machine 1 is, for example, a motor vehicle lifting device, a motor vehicle brake test stand, a motor vehicle dynamometer, or the like. The machine may in particular comprise vehicle lifting devices, vehicle brake test stands, vehicle test lanes, vehicle dynamometers, exhaust gas measuring devices, and/or other test devices for motor vehicles.

The control device 110, illustrated in greater detail in FIG. 3, is wirelessly or cordlessly connected to a network, preferably the Internet. A background management system 2 which stores electronic device files 201-203 (more or fewer than three device files are possible) for each individual machine 1 is connected to the network. A dedicated device file 201-203 is thus associated with each machine 1. The device file 201-203 may be viewed by authorized users. This takes place, for example, by connecting a user device 3a-3b, for example a PC, smart phone, or the like, to the background management system 2. For this purpose a data link 5, in the present case 5c1, 5c2, or 5c3, for example, is established which may use the HTTP protocol and the HTM display. A user may then retrieve stored data of the device file 201-203 of a certain machine 1 for which he/she is authorized, track telemetry data in real time, remotely control the machine 1, and so forth.

The control device 110 sends and receives data via a wireless transmit/receive unit 1102, shown in FIG. 3. The wireless transmit/receive unit 1102 is preferably a WLAN module or a Bluetooth module situated on the circuit board of the control device. The wireless transmit/receive unit 1102 may establish a wireless connection 5a with the network via a router 4 or some other network gateway unit. Data may then be sent and received in real time between the control device 110, via the data links 5a-5c to the background management system 2, and user device(s) 3a-3c connected thereto.

In addition, FIG. 2 shows, for example, a start-up of the machine 1. The control device 110, as schematically shown in FIG. 3, has one or more terminals 1106 for cable connections, for example USB, mini-USB, etc., to which a service technician connects a computer 6 or a mobile Internet-capable terminal via a cable connection 5d during start-up. Furthermore, a data link 5e is established with the network. In this system configuration, the firmware of the machine 1 that was not installed on the control device 110 prior to start-up is downloaded from the background management system 2 and installed on the control device 110. The terminal 1106 for cable connections may be “activatable” or enabled via an optional mechanical bridge 1107 (FIG. 3). Likewise, the terminal 1106 may alternatively be used for cable connections when the wireless connection 5a is not supposed to be/cannot be established, for example during maintenance or repair of the machine 1 or in the event of a defect of the wireless transmit/receive unit 1102.

FIG. 3 also shows the control device 110 and the electrical connections 1110 to the actuators and sensors 120-123, 130-132 of the machine 1. The connections 1110 may have a cordless or corded design. Bus connections or individual connections may be used. Status values, sensor measured values, control commands, etc., are exchanged or transmitted between the actuators and sensors 120-123, 130-132 and the control device 110 via the connections 1110. The connections are connected to the input or inputs 1104 and the output or outputs 1105 of the control device 110. The control device 110 is preferably situated on a circuit board or is particularly preferably formed by the circuit board on which the mentioned inputs and outputs 1104, 1105 are situated, as well as the cable data terminal 1106, a voltage terminal 1107, the described bridge 1108, and additional data link terminals 1109. Also situated on the circuit board are the wireless transmit/receive unit 1102 and a processing unit 1103, which may be jointly situated in a core module 1101. The strip conductors or cable lines 1120 are shown in FIG. 3 strictly by way of example. The above-mentioned components of the control device 110 may also be electrically connected to one another in some other way. For example, the lines shown between the core module 1101 and the inputs/outputs 1104, 1105 may be omitted and replaced by individual connections 1120 between the inputs/outputs 1104, 1105 and the wireless transmit/receive unit 1102 and/or the processing unit 1103. It is advantageous that the control device 110 has a preferably small number of components, so that its complexity and manufacturing costs remain low, and that a unit for cordless or wireless transmission and reception of data is directly integrated. The latter makes it possible, among other things, to send data directly to the background management system 2 without a PC connected in between.

The (raw) data that are entered into the background management system 2 for each device file 201-204 or machine 1 are stored and evaluated to allow a user to be provided with processed information concerning, for example, the status of the machine and/or its use. For example, if it is observed that no voltage has been applied to the machine 1 for an extended period of time, a service technician or the like is sent a message from the background management system 2 that provides notification that the system may have been taken out of operation. For a lifting platform having two columns, the jack screws or hydraulic valves may also be monitored. If it is determined, for example, that these elements output different operating values or status values for an extended period of time, a message from the background management system 2 may provide notification that it may be necessary to perform maintenance of these components in order to prevent a possible defect. Load sensors may also provide information as to whether a lifting device is being used within the weight specifications. The background management system 2 is configured in such a way that the raw data are processed into meaningful, quickly interpretable evaluation data and/or evaluation messages. The following is one example of an evaluation message: The values of a temperature sensor of an actuator of the machine 1 are monitored. A predetermined pattern of the temperature profile is detected by the evaluation logic system of the main management system 2 (preferably in an automated manner), for example the exceedance of a time-averaged value of the measured temperature values over a predetermined continuous time period. In this case, a determined defect that is immediately imminent or a defect that is correlated with the observed temperature profile pattern is identified in an automated manner, and a responsible service technician is notified. The information may be, for example, that the actuator in question is likely to become defective soon, and should preferably be replaced in the near future.

In addition, sending telemetry data allows a user to monitor and remotely control the machine 1, which the user may request on a user device 3a-3c, for example by means of a service provided by the background management system 2, such as a graphical human-machine interface that may be called up on the Internet.

Furthermore, the background management system 2 may also be configured so that actions of the machine 1 are subject to the condition of being enabled by the background management system 2, for example to prevent unauthorized access and use of the test device, or to allow use-based cost and lease applications. For example, the firmware of the control device 110 may be configured in such a way that prior to carrying out an action, for example lifting a load arm of a lifting platform, a request is initially sent to the background management system 2, which then sends back an enable command.

Moreover, emergency procedures may also be implemented by means of the control device 110 or with the background management system 2 in the integrated system. For example, inputting a specified emergency sequence on a keyboard of the test device 1 may trigger a direct message, transmitted via the network and the background management system 2, to a service technician. The service technician may then immediately carry out a diagnosis of the emergency based on the real-time data from the machine 1.

In summary, a machine 1 or a control device 110 may be provided which is connected to and communicates with a background management system 2 directly, cordlessly, and in real time. The system comprising the machine 1 or the control device 110 and the background management system 2 thus opens up new technical possibilities by means of which the machine 1 may, among other things, be maintained and repaired with better planning capability and more cost-effectively, and operated more reliably and with more productive time.

1. A control device for controlling a machine that is configured for exchanging data with one or more actuators of the machine and/or for exchanging data with one or more sensors of the machine, the control device having a processing unit that is configured for controlling the actuators of the machine and retrieving data from the sensors, and a wireless transmit/receive unit that is configured for wirelessly transmitting data from the actuators and/or sensors to one or more networks and/or for receiving data from the network.

2. The control device according to claim 1, wherein the network is connected to a background management system to which the data of the control device are transmitted, and/or from which data are transmitted to the control device.

3. The control device according to claim 1, wherein the control device has a circuit board on which the processing unit and the wireless transmit/receive unit are situated, and these are electrically connected to one another by means of strip conductors, the circuit board also having inputs and outputs for lines to and from the actuators and/or sensors, and a power supply connection.

4. The control device according to claim 1, wherein the control device prior to start-up of the machine contains no firmware stored in memory, and the control device is configured for obtaining or receiving via transmission the firmware from the background management system by means of a data link via the network and storing same, and the control device is also configured for obtaining or receiving via transmission firmware updates from the background management system by means of a data link via the network and storing same.

5. The control device according to claim 1, wherein the data link to the background management system includes at least one wired data link path between the control device and a network- and/or Internet-capable device, and at least one cordless or corded data link path between the network- and/or Internet-capable device and the background management system.

6. The control device according to claim 1, wherein the wireless transmit/receive unit has a cryptography module that is configured for encrypting or decrypting data that are sent or received by the wireless transmit/receive unit, or for providing the data with a digital signature.

7. The control device according to claim 1, wherein the control device is configured for wirelessly transmitting data to the background management system via the network at predetermined time intervals, which may be regular.

8. The control device according to claim 1, wherein the control device is configured for wirelessly transmitting data to the background management system via the network at predetermined time intervals, which may be regular, wherein
the transmitted data include measuring data of the sensor or sensors of the machine and/or measuring data or status data of the actuator or actuators of the machine.

9. The control device according to claim 1, wherein the control device is configured for wirelessly transmitting data to the background management system via the network at predetermined time intervals, which may be regular, by means of Message Queue Telemetry Transport (MQTT) protocol.

10. A background management system that is configured for obtaining data by transmission from a control device or transmitting to same according to claim 1, the background management system being connected to one or more networks and including a plurality of computers that are configured for receiving, storing, and processing data and/or transmitting data to the control device or to a user device connected to the network.

11. The background management system according to claim 10, wherein the background management system is configured for outputting data to a user device via Hypertext Markup Language Protocol, and updating the display thereof at predetermined time intervals.

12. The background management system according to claim 10, wherein the background management system is configured for storing for each control device or machine a digital device file that contains information concerning the machine, wherein the data of the device file are stored in encrypted form.

13. The background management system according to claim 10, wherein the background management system is configured for evaluating raw data of the sensors and actuators of the machine transmitted from the control device, and generating evaluation data.

14. The background management system according to claim 10, wherein the background management system is configured for evaluating raw data of the sensors and actuators of the machine transmitted from the control device, and generating evaluation data, wherein the background management system is configured for automatically transmitting the evaluation data to a user device when a predefined event has been identified during the evaluation.

15. A system including the background management system according to claim 10 and a control device for controlling a machine that is configured for exchanging data with one or more actuators of the machine and/or for exchanging data with one or more sensors of the machine, the control device having a processing unit that is configured for controlling the actuators of the machine and retrieving data from the sensors, and a wireless transmit/receive unit that is configured for wirelessly transmitting data from the actuators and/or sensors to one or more networks and/or for receiving data from the network.

16. The system including the background management system according to claim 10 and a control device for controlling a machine that is configured for exchanging data with one or more actuators of the machine and/or for exchanging data with one or more sensors of the machine, the control device having a processing unit that is configured for controlling the actuators of the machine and retrieving data from the sensors, and a wireless transmit/receive unit that is configured for wirelessly transmitting data from the actuators and/or sensors to one or more networks and/or for receiving data from the network,
wherein the control device is configured so that, after receiving a predetermined command sequence, the control device transmits an emergency signal to the background management system, and the background management system delivers a call or a message to a predetermined contact point.

17. The system including the background management system according to claim 10 and a control device for controlling a machine that is configured for exchanging data with one or more actuators of the machine and/or for exchanging data with one or more sensors of the machine, the control device having a processing unit that is configured for controlling the actuators of the machine and retrieving data from the sensors, and a wireless transmit/receive unit that is configured for wirelessly transmitting data from the actuators and/or sensors to one or more networks and/or for receiving data from the network,
wherein the control device is configured so that, prior to sending a control command to an actuator of the machine, the control device transmits a request to the background management system, and does not send the control command when the background management system does not enable sending of the control command.

18. A method for transmitting data between a control device according to claim 1 and a background management that is configured for obtaining data by transmission from a control device or transmitting to same, the background management system being connected to one or more networks and including a plurality of computers that are configured for receiving, storing, and processing data and/or transmitting data to the control device or to a user device connected to the network,
wherein a network- and/or Internet-capable device is connected to the control device via a cable connection, the network- and/or Internet-capable device is connected to a network to which the background management system is connected, and data are downloaded from a memory location in the background management system that is predetermined for the machine and are stored in the control device, and/or data are transmitted from the control device to the background management system; or
a wireless data link is established between the control device and a router, the router being connected to a network to which the background management system is connected, and data are downloaded from a memory location in the background management system that is predetermined for the machine and are stored in the control device, or data are transmitted from the control device to the background management system.

19. A method for the maintenance or repair of a machine having a control device according to claim 1, wherein a user obtains data, transmitted from the background management system via a data link, that contain information concerning the status of the machine or individual components, and the user, either at his/her own discretion or upon occurrence of a predetermined event, automatically receives determination or notice of the need for maintenance or repair, the information displaying a component to be maintained/repaired.
